(19) United States
(12) Patent Application Publication
(10) Pub. No.: US 2024/0112838 A1
(43) Pub. Date: Apr. 4, 2024

(54) METHOD OF PRODUCING PHOSPHATE-COATED SmFeN-BASED ANISOTROPIC MAGNETIC POWDER

(71) Applicant: NICHIA CORPORATION, Anan-shi (JP)

(72) Inventors: Masahiro ABE, Tokushima-shi (JP); Shuichi TADA, Komatsushima-shi (JP); Satoshi YAMANAKA, Tokushima-shi (JP); Kenta IWAI, Anan-shi (JP)

(73) Assignee: NICHIA CORPORATION, Anan-shi (JP)

(21) Appl. No.: 18/477,949

(22) Filed: Sep. 29, 2023

(30) Foreign Application Priority Data
Sep. 30, 2022 (JP) 2022-158329

(51) Int. Cl. H01F 1/059; B22F 1/142; B22F 1/145; B22F 1/16; H01F 1/055

(52) U.S. Cl. CPC H01F 1/059; B22F 1/142; B22F 1/145; B22F 1/16; H01F 1/0551; B22F 2201/02; B22F 2201/03; B22F 2201/11; B22F 2201/20; B22F 2301/355; B22F 2302/45; B22F 2998/10

(57) ABSTRACT

A method of producing a phosphate-coated SmFeN-based anisotropic magnetic powder, the method including stirring a slurry containing a raw material SmFeN-based anisotropic magnetic powder, water, a phosphate source, and an aluminum source to obtain a SmFeN-based anisotropic magnetic powder having a surface coated with a phosphate.

### CROSS-REFERENCE TO RELATED PATENT APPLICATION

This application claims priority to Japanese Patent Application No. 2022-158329 filed on Sep. 30, 2022. The disclosure of Japanese Patent Application No. 2022-158329 is hereby incorporated by reference in its entirety.

### BACKGROUND

The present disclosure relates to a method of producing a phosphate-coated SmFeN-based anisotropic magnetic powder.

SmFeN-based anisotropic magnetic powders are known to have an enhanced intrinsic coercive force when their surfaces are coated with phosphates. For example, JP 2020-056101 A discloses a method of adding a pH-adjusted phosphate treatment liquid containing orthophosphoric acid to a slurry containing a SmFeN-based anisotropic magnetic powder and water as a solvent to form a phosphate coating on the surface of the SmFeN-based anisotropic magnetic powder.

JP 2017-210662 A discloses a method of adding a pH-adjusted phosphate treatment liquid to a slurry containing a SmFeN-based anisotropic magnetic powder having a large particle size and an organic solvent, and then milling the SmFeN-based anisotropic magnetic powder into smaller particles while forming a phosphate coating on the surface of the SmFeN-based anisotropic magnetic powder.

JP 2014-160794 A discloses that slow oxidation of a SmFeN-based anisotropic magnetic powder provided with a phosphate coating increases the intrinsic coercive force of the magnetic powder.

### SUMMARY

The present disclosure aims to provide a method of producing a phosphate-coated SmFeN-based anisotropic magnetic powder having a much higher intrinsic coercive force and excellent oxidation resistance.

Exemplary embodiments of the present disclosure relate to a method of producing a phosphate-coated SmFeN-based anisotropic magnetic powder, the method including a phosphate treatment including stirring a slurry containing a raw material SmFeN-based anisotropic magnetic powder, water, a phosphate source, and an aluminum source to obtain a SmFeN-based anisotropic magnetic powder having a surface coated with a phosphate.

The above embodiments can provide a method of producing a phosphate-coated SmFeN-based anisotropic magnetic powder having a much higher intrinsic coercive force and excellent oxidation resistance.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

### Method of Producing Phosphate-coated SmFeN-based Anisotropic Magnetic Powder

A method of producing a phosphate-coated SmFeN-based anisotropic magnetic powder according to the present embodiments includes a phosphate treatment including stifling a slurry containing a raw material SmFeN-based anisotropic magnetic powder, water, a phosphate source, and an aluminum source to obtain a SmFeN-based anisotropic magnetic powder having a surface coated with a phosphate.

### Phosphate Treatment Step

In the phosphate treatment step, a slurry containing a raw material SmFeN-based anisotropic magnetic powder, water, a phosphate source, and an aluminum source is stirred to obtain a SmFeN-based anisotropic magnetic powder having a surface coated with a phosphate.

The raw material SmFeN-based anisotropic magnetic powder may be a nitride having a Th2Zn17-type crystal structure and containing the rare earth metal samarium (Sm), iron (Fe), and nitrogen (N) as represented by the general formula: SmxFe100-x-yNy, preferably wherein x is at least 8.1 atom % but not more than 10 atom %; y is at least 13.5 atom % but not more than 13.9 atom %; and the balance is mainly Fe.

The phosphate-coated SmFeN-based anisotropic magnetic powder can be formed by reacting the metal component (for example, iron, samarium) in the raw material SmFeN-based anisotropic magnetic powder with the phosphate in the phosphate source to precipitate a phosphate (for example, iron phosphate, samarium phosphate) on the surface of the raw material SmFeN-based anisotropic magnetic powder. Further, as the aluminum source is also present in the slurry, an aluminum compound can be precipitated on the surface of the raw material SmFeN-based anisotropic magnetic powder. Moreover, as water is used as a solvent according to the present embodiments, a phosphate having a small particle size can be precipitated as compared to when an organic solvent is used. Thus, the resulting phosphate-coated SmFeN-based anisotropic magnetic powder has a dense coating. The combined use of the aluminum source in such a phosphate treatment using water as a solvent enables the production of a SmFeN-based anisotropic magnetic powder having a much higher intrinsic coercive force. This is believed to be because, for example, the presence of the aluminum source in the phosphate treatment can allow a phosphate to be formed more densely or in a larger amount on the surface of the raw material SmFeN-based anisotropic magnetic powder, thereby enhancing the effect of the phosphate coating.

The amount of the raw material SmFeN-based anisotropic magnetic powder in the slurry may be, for example, at least 1% by mass but not more than 50% by mass. In view of productivity, the amount is preferably at least 5% by mass but not more than 20% by mass.

The phosphate source may be any phosphate compound that can generate phosphate (PO4) in the slurry. Examples include inorganic phosphoric acids and salts thereof such as orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid, hypophosphites, pyrophosphoric acid, and polyphosphoric acid, and organic phosphoric acids and salts thereof. These may be used alone or in combinations of two or more. Inorganic phosphoric acids and salts thereof are preferred among these because the resulting phosphate-coated SmFeN-based anisotropic magnetic powder has a much lower carbon content, so that the phosphate coating can have a greater effect. Moreover, in order to enhance the water resistance and corrosion resistance of the coating and the magnetic properties of the magnetic powder, additives may further be added including, for example, oxoacid salts such as molybdates, tungstates, vanadates, and chromates; oxidizing agents such as sodium nitrate and sodium nitrite; and chelating agents such as EDTA.

The amount of the phosphate source, calculated as phosphate (PO4), in the slurry may be, for example, at least 5% by mass but not more than 50% by mass. In view of the solubility, storage stability, and ease of chemical conversion of the phosphate compound, the amount is preferably at least 10% by mass but not more than 30% by mass.

The aluminum source may be any aluminum compound that can generate aluminum ions (Al3+) in the slurry. Examples include aluminum chloride, aluminum sulfate, aluminum acetate, aluminum hydroxide, and aluminum phosphate. These may be used alone or in combinations of two or more. In view of the solubility and ease of chemical conversion of the aluminum compound, aluminum chloride or aluminum sulfate is preferred among these.

To minimize a reduction in the magnetic properties of the magnetic powder to be obtained, the amount of the aluminum source, for example, when it is aluminum chloride, in the slurry is preferably at least 0.05 parts by mass but not more than 2.5 parts by mass, more preferably at least 0.1 parts by mass but not more than 2 parts by mass, still more preferably at least 0.2 parts by mass but not more than 1.8 parts by mass, per 100 parts by mass of the raw material SmFeN-based anisotropic magnetic powder in the slurry.

The amount of the aluminum element in the aluminum source in the slurry is preferably not higher than 0.02 mol, more preferably not higher than 0.015 mol, per 100 g of the raw material SmFeN-based anisotropic magnetic powder. When the amount of the aluminum element is not higher than 0.02 mol, the intrinsic coercive force and oxidation resistance of the magnetic powder tend to be further enhanced. The lower limit is not limited, and it is generally at least 0.001 mol.

The slurry may further contain a calcium source in addition to the raw material SmFeN-based anisotropic magnetic powder, water, phosphate source, and aluminum source. As the slurry contains a calcium source, calcium may bind to the magnetic powder, thereby further enhancing oxidation resistance and water resistance.

The calcium source may be any calcium compound that can generate calcium ions (Ca2+) in the slurry. Examples include calcium chloride, calcium sulfate, calcium acetate, and calcium hydroxide. These may be used alone or in combinations of two or more. In view of the solubility and ease of chemical conversion of the calcium compound, calcium chloride is preferred among these.

The calcium element content of the calcium source in the slurry is preferably not higher than 0.02 mol, more preferably not higher than 0.015 mol, per 100 g of the raw material SmFeN-based anisotropic magnetic powder. When the calcium element content is not higher than 0.02 mol, the oxidation resistance and water resistance of the magnetic powder tend to be enhanced. The lower limit is not limited, and it is generally at least 0.001 mol.

The slurry containing a raw material SmFeN-based anisotropic magnetic powder, water, a phosphate source, and an aluminum source, and optionally a calcium source may be prepared by any method which may include mixing the components in any order. Preferably, a raw material SmFeN-based anisotropic magnetic powder and an aluminum source, and optionally a calcium source are mixed in advance, and then an aqueous phosphate solution containing a phosphate source and water is added to the mixture. The rate of stirring the slurry is preferably at least 100 rpm but not higher than 1000 rpm. In view of the reaction efficiency and ease of control, the temperature during the stirring of the slurry is preferably at least 5° C. but not higher than 45° C., more preferably at least 10° C. but not higher than 25° C.

In the phosphate treatment step, an inorganic acid may be added to the slurry to adjust the pH of the slurry to at least 1 but not higher than 4.5. The pH is preferably adjusted to at least 1.6 but not higher than 3.9, more preferably at least 2 but not higher than 3. When the pH is adjusted to at least 1, the phosphate-coated SmFeN-based anisotropic magnetic powder particles can be prevented from aggregating starting from the locally highly precipitated phosphate, resulting in an enhanced intrinsic coercive force. When the pH is adjusted to not higher than 4.5, it is possible to prevent insufficient coating caused by a decrease in the amount of the precipitated phosphate, thereby resulting in an enhanced intrinsic coercive force. Examples of the inorganic acid include hydrochloric acid, nitric acid, sulfuric acid, boric acid, and hydrofluoric acid. In the phosphate treatment step, the inorganic acid is preferably added as required to adjust the pH within the above-mentioned range. Although the inorganic acid is used in view of liquid waste disposal, an organic acid may be used together depending on the purpose. Examples of the organic acid include acetic acid, formic acid, and tartaric acid. A mixture of an inorganic acid and an organic acid is also usable.

The adjustment of the pH of the slurry by the addition of an inorganic acid is preferably performed for at least 10 minutes. To reduce the thin parts of the coating, the adjustment is more preferably performed for at least 30 minutes. In maintaining the pH, the pH initially increases rapidly, and therefore the inorganic acid for pH control should be introduced at short intervals. Then, as the phosphate coating of the surface of the raw material SmFeN-based anisotropic magnetic powder proceeds, the pH changes gently, which allows the inorganic acid to be introduced at longer intervals. This allows one to determine the end point of the reaction.

### Oxidation Step After Phosphate Treatment

The phosphate treatment step may be followed by an oxidation step which includes heat-treating the SmFeN-based anisotropic magnetic powder having a surface coated with a phosphate at a temperature of at least 150° C. but not higher than 330° C. in an oxygen-containing atmosphere. In the oxidation step, the surface of the base material SmFeN-based anisotropic magnetic powder coated with a phosphate may be oxidized by, for example, slow oxidation to form a thick iron oxide layer which tends to enhance the hot water resistance of the SmFeN-based anisotropic magnetic powder having a surface coated with a phosphate.

The oxidation step after phosphate treatment may be carried out by heat-treating the SmFeN-based anisotropic magnetic powder having a surface coated with a phosphate in an oxygen-containing atmosphere. The reaction atmosphere preferably contains oxygen in an inert gas such as nitrogen or argon. The oxygen concentration is preferably at least 3% but not more than 21%, more preferably at least 3.5% but not more than 10%. During the oxidation reaction, gas exchange is preferably performed at a flow rate of at least 2 L/min but not higher than 10 L/min per 1 kg of the magnetic powder.

The heat treatment temperature during the oxidation step after phosphate treatment is at least 150° C. but not higher than 330° C., preferably at least 200° C. but not higher than 330° C., more preferably at least 200° C. but not higher than 250° C., still more preferably at least 210° C. but not higher than 230° C. When the temperature is at least 150° C., the formation of an iron oxide layer can be promoted, and hot water resistance can be enhanced. When the temperature is not higher than 330° C., excessive formation of an iron oxide layer can be prevented, and intrinsic coercive force can be enhanced. The duration of heat treatment is preferably at least 3 hours but not longer than 10 hours.

### Silica Treatment Step

The SmFeN-based anisotropic magnetic powder obtained through the phosphate treatment step may optionally be subjected to a silica treatment. Formation of a silica thin film on the magnetic powder can enhance oxidation resistance. The silica thin film may be formed, for example, by mixing an alkyl silicate, the phosphate-coated SmFeN-based anisotropic magnetic powder, and an alkali solution.

### Silane Coupling Treatment Step

The magnetic powder obtained after the silica treatment may be further treated with a silane coupling agent. When the magnetic powder with a silica thin film formed thereon is subjected to a silane coupling treatment, a coupling agent film is formed on the silica thin film, which can improve the magnetic properties of the magnetic powder as well as the wettability between the magnetic powder and the resin and the magnet strength. Any silane coupling agent may be used and may be selected depending on the type of resin. Examples of the silane coupling agent include 3-aminopropyltriethoxysilane, γ-(2-aminoethyl)aminopropyltrimethoxysilane, γ-(2-aminoethyl)aminopropylmethyldimethoxysilane, γ-methacryloxypropyltrimethoxysilane, γ-methacryloxypropylmethyldimethoxysilane, N-β-(N-vinylbenzylaminoethyl)-γ-aminopropyltrimethoxysilane hydrochloride, γ-glycidoxypropyltrimethoxysilane, γ-mercaptopropyltrimethoxysilane, methyltrimethoxysilane, methyltriethoxysilane, vinyltriacetoxysilane, γ-chloropropyltrimethoxysilane, hexamethylenedisilazane, γ-anilinopropyltrimethoxysilane, vinyltrimethoxysilane, octadecyl[3-(trimethoxysilyl)propyl]ammonium chloride, γ-chloropropylmethyldimethoxysilane, γ-mercaptopropylmethyldimethoxysilane, methyltrichlorosilane, dimethyldichlorosilane, trimethylchlorosilane, vinyltrichlorosilane, vinyltris(β-methoxyethoxy)silane, vinyltriethoxysilane, β-(3,4-epoxycyclohexyl)ethyltrimethoxysilane, γ-glycidoxypropylmethyldiethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, ureidopropyltriethoxysilane, γ-isocyanatopropyltriethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyltrimethoxysilane, vinylmethyldimethoxysilane, 1,3,5-N-tris(3-trimethoxysilylpropyl)isocyanurate, t-butyl carbamate trialkoxysilane, and N-(1,3-dimethylbutylidene)-3-(triethoxysilyl)-1-propaneamine. These silane coupling agents may be used alone or in combinations of two or more. The amount of the silane coupling agent added per 100 parts by mass of the magnetic powder is preferably at least 0.2 parts by mass but not more than 0.8 parts by mass, more preferably at least 0.25 parts by mass but not more than 0.6 parts by mass. If the amount is less than 0.2 parts by mass, the effect of the silane coupling agent tends to be small. If the amount is more than 0.8 parts by mass, the magnetic properties of the magnetic powder or magnet tend to decrease due to aggregation of the magnetic powder.

The SmFeN-based anisotropic magnetic powder obtained after the phosphate treatment step, oxidation step, silica treatment, or silane coupling treatment may be filtered, dehydrated, and dried in a usual manner.

### Phosphate-coated SmFeN-based Anisotropic Magnetic Powder

The average particle size of the phosphate-coated SmFeN-based anisotropic magnetic powder obtained by the production method according to the present embodiments is preferably at least 2 μm but not more than 5 μm, more preferably at least 2.5 μm but not more than 4.8 μm. When the average particle size is at least 2 μm, the amount of the magnetic powder filled in the bonded magnet can be increased, facilitating improvement of magnetization. When the average particle size is not more than 5 μm, the bonded magnet tends to have an enhanced intrinsic coercive force. Herein, the average particle size is measured under dry conditions using a laser diffraction particle size distribution analyzer. For example, it can be measured with a laser diffraction particle size distribution analyzer (HELOS & RODOS available from Japan Laser Corporation).

The particle size D10 of the phosphate-coated SmFeN-based anisotropic magnetic powder is preferably at least 1 μm but not more than 3 μm, more preferably at least 1.5 μm but not more than 2.5 μm. When the D10 is at least 1 μm, the amount of the magnetic powder filled in the bonded magnet can be increased, facilitating improvement of magnetization. When the D10 is not more than 3 μm, the bonded magnet tends to have an enhanced intrinsic coercive force. Herein, the D10 is defined as the particle size corresponding to the 10th percentile of the cumulative particle size distribution by volume of the phosphate-coated SmFeN-based anisotropic magnetic powder.

The particle size D50 of the phosphate-coated SmFeN-based anisotropic magnetic powder is preferably at least 2.5 μm but not more than 5 μm, more preferably at least 2.7 μm but not more than 4.8 μm. When the D50 is at least 2.5 μm, the amount of the magnetic powder filled in the bonded magnet can be increased, facilitating improvement of magnetization. When the D50 is not more than 5μm, the bonded magnet tends to have an enhanced intrinsic coercive force. Herein, the D50 is defined as the particle size corresponding to the 50th percentile of the cumulative particle size distribution by volume of the phosphate-coated SmFeN-based anisotropic magnetic powder.

The particle size D90 of the phosphate-coated SmFeN-based anisotropic magnetic powder is preferably at least 3 μm but not more than 7 μm, more preferably at least 4 μm but not more than 6 μm. When the D90 is at least 3 μm, the amount of the magnetic powder filled in the bonded magnet can be increased, facilitating improvement of magnetization. When the D90 is not more than 7 μm, the bonded magnet tends to have an enhanced intrinsic coercive force. Herein, the D90 is defined as the particle size corresponding to the 90th percentile of the cumulative particle size distribution by volume of the phosphate-coated SmFeN-based anisotropic magnetic powder.

In view of intrinsic coercive force, the phosphate-coated SmFeN-based anisotropic magnetic powder preferably has a below-defined span of not more than 2, more preferably not more than 1.5:

Span=(D90−D10)/D50.

The circularity of the phosphate-coated SmFeN-based anisotropic magnetic powder is not limited, and it is preferably at least 0.5, more preferably at least 0.6. When the circularity is at least 0.5, fluidity can be enhanced, and stress between the particles during molding can be reduced, resulting in improved magnetic properties. Herein, the circularity can be determined by taking a SEM image at a magnification of 3000, processing the image for binarization, and calculating the circularity of each particle. The circularity defined in the present disclosure refers to the average of the circularities obtained by measuring about 1,000 to 10,000 particles. In general, the larger the number of small size particles, the higher the circularity. Thus, particles having a particle size of at least 1 μm are measured for circularity. The circularity measurement uses the definitional equation: Circularity=4πS/L2, wherein S represents the area of the two-dimensional projection of the particle, and L represents the perimeter of the two-dimensional projection thereof.

The DSC exothermic onset temperature of the phosphate-coated SmFeN-based anisotropic magnetic powder is preferably at least 170° C., more preferably at least 200° C., still more preferably at least 260° C. The DSC exothermic onset temperature indicates an overall evaluation of the properties of the phosphate coating, including density, thickness, and oxidation resistance. A high intrinsic coercive force can be obtained when the DSC exothermic onset temperature is at least 170° C.

The phosphate-coated SmFeN-based anisotropic magnetic powder preferably has a XRD diffraction pattern in which the ratio (I)/(II) of the diffraction peak intensity (I) of the (110) plane of αFe to the diffraction peak intensity (II) of the (300) plane of the SmFeN-based anisotropic magnetic powder is not higher than 2.0×10−2, more preferably not higher than 1.0×10−2. The diffraction peak intensity (I) of the (110) plane of αFe indicates the abundance of αFe as an impurity. A high intrinsic coercive force can be obtained when the ratio (I)/(II) is not higher than 2.0×10−2. Here, the diffraction peak intensities in the XRD diffraction pattern may be measured using a powder X-ray crystal diffraction instrument (available from Rigaku Corporation, X-ray wavelength: CuKa1), and the measured diffraction peak intensity of the (110) plane of αFe may be divided by the diffraction peak intensity of the (300) plane of Sm2Fe17N3 and then multiplied by 10,000 to obtain a value as an αFe peak height ratio. A lower αFe peak height ratio means a smaller amount of αFe as an impurity.

The phosphate-coated SmFeN-based anisotropic magnetic powder preferably has a carbon content of not higher than 1000 ppm, more preferably not higher than 800 ppm. The carbon content indicates the amount of organic impurities in the phosphate. When the carbon content is not higher than 1000 ppm, it is possible to reduce the occurrence of defects in the coating caused by the decomposition of organic impurities when the phosphate-coated SmFeN-based anisotropic magnetic powder is exposed to high temperatures during the process of producing a bonded magnet. This tends to result in an enhanced intrinsic coercive force. Here, the carbon content can be measured by a TOC method.

The phosphate-coated SmFeN-based anisotropic magnetic powder preferably has a phosphate content of higher than 0.5% by mass, more preferably at least 0.55% by mass, still more preferably at least 0.75% by mass, particularly preferably at least 0.9% by mass. Moreover, the upper limit of the phosphate content is preferably 4.5% by mass or lower, more preferably 2.5% by mass or lower, still more preferably 2% by mass or lower. When the phosphate content is higher than 0.5% by mass, the effect of the phosphate coating tends to increase. When the phosphate content is 4.5% by mass or lower, it tends to be possible to prevent a reduction in intrinsic coercive force caused by aggregation of the phosphate-coated SmFeN-based anisotropic magnetic powder particles. Here, the phosphate content of the magnetic powder is determined by ICP atomic emission spectroscopy (ICP-AES) and expressed as the amount of PO4 molecules.

In view of the intrinsic coercive force of the phosphate-coated SmFeN-based anisotropic magnetic powder, the phosphate-coated SmFeN-based anisotropic magnetic powder preferably has a phosphate coating having a thickness of at least 10 nm but not more than 200 nm. Here, the thickness of the phosphate coating may be measured by performing composition analysis using an EDX line scan on a cross section of the phosphate-coated SmFeN-based anisotropic magnetic powder.

The aluminum content of the phosphate-coated SmFeN-based anisotropic magnetic powder is preferably more than 0.03% by mass, more preferably at least 0.05% by mass. Moreover, the upper limit of the aluminum content is preferably not more than 0.40% by mass, more preferably not more than 0.30% by mass. When the aluminum content is not more than 0.40% by mass, aggregation is less likely to occur during the phosphate precipitation reaction, and it tends to be possible to reduce deterioration in the magnetic properties of the resulting anisotropic magnetic powder. When the aluminum content is at least 0.03% by mass, the presence of aluminum tends to have a greater effect on improving magnetic properties. Here, the aluminum content of the magnetic powder is measured by ICP atomic emission spectroscopy (ICP-AES).

When the slurry in the phosphate treatment step contains a calcium source, the calcium content of the resulting phosphate-coated SmFeN-based anisotropic magnetic powder is preferably more than 0.01% by mass, more preferably at least 0.02% by mass. Moreover, the upper limit of the calcium content is preferably not more than 0.10% by mass, more preferably not more than 0.05% by mass. When the calcium content is not more than 0.10% by mass, it tends to be possible to reduce deterioration in magnetic properties. When the calcium content is at least 0.01% by mass, the calcium, when present with aluminum, tends to further enhance water resistance. Here, the calcium content of the magnetic powder is measured by ICP atomic emission spectroscopy (ICP-AES).

### Method of Producing Raw Material SmFeN-based Anisotropic Magnetic Powder

In the above-described method of producing a phosphate-coated SmFeN-based anisotropic magnetic powder, the raw material SmFeN-based anisotropic magnetic powder used in the phosphate treatment step is not limited, but it may suitably be, for example, one produced by a method including:
mixing a solution containing Sm and Fe with a precipitant to obtain a precipitate containing Sm and Fe (precipitation step);
firing the precipitate to obtain an oxide containing Sm and Fe (oxidation step);
heat-treating the oxide in a reducing gas-containing atmosphere to obtain a partial oxide (pretreatment step);
reducing the partial oxide (reduction step); and
nitriding the alloy particles obtained in the reduction step (nitridation step).

### Precipitation Step

In the precipitation step, a Sm raw material and a Fe raw material may be dissolved in a strong acid solution to prepare a solution containing Sm and Fe. When it is desired to obtain Sm2Fe 17N3 as the main phase, the molar ratio of Sm and Fe (Sm:Fe) is preferably 1.5:17 to 3.0:17, more preferably 2.0:17 to 2.5:17. A raw material such as La, W, Co, Ti, Sc, Y, Pr, Nd, Pm, Gd, Tb, Dy, Ho, Er, Tm, or Lu may be added to the solution.

Any Sm or Fe raw material which can be dissolved in a strong acid solution may be used. In view of availability, examples of the Sm raw material include samarium oxide, and examples of the Fe raw material include FeSO4. The concentration of the solution containing Sm and Fe may be appropriately adjusted within a range in which the Sm raw material and the Fe raw material can be substantially dissolved in the acid solution. In view of solubility, examples of the acid solution include sulfuric acid.

The solution containing Sm and Fe may be reacted with a precipitant to obtain an insoluble precipitate containing Sm and Fe. Here, it is sufficient that the solution containing Sm and Fe contain Sm and Fe at the time of the reaction with a precipitant. For example, a solution containing a Sm raw material and a solution containing a Fe raw material may be prepared separately, and then added dropwise individually to react with a precipitant. The separate solutions to be prepared may also be appropriately adjusted within a range in which the respective raw materials can be substantially dissolved in the acid solution. The precipitant may be any alkaline solution that can react with the solution containing Sm and Fe to give a precipitate. Examples include an aqueous ammonia solution and caustic soda, with caustic soda being preferred.

To easily control the particle properties of the precipitate, the precipitation reaction is preferably carried out by separately dropwise adding the solution containing Sm and Fe and the precipitant to a solvent such as water. A precipitate having a homogeneous element distribution, a sharp particle size distribution, and a uniform particle shape can be obtained by appropriately controlling the feeding rates of the solution containing Sm and Fe and the precipitant, the reaction temperature, the concentration of the reaction solution, the pH during the reaction, and other conditions. The use of such a precipitate enhances the magnetic properties of the resulting raw material magnetic powder. The reaction temperature may be 0 to 50° C., preferably 35 to 45° C. The concentration of the reaction solution, expressed as the total concentration of metal ions, is preferably 0.65 mol/L to 0.85 mol/L, more preferably 0.7 mol/L to 0.84 mol/L. The pH during the reaction is preferably 5 to 9, more preferably 6.5 to 8.

The precipitate obtained in the precipitation step roughly determines the particle size, particle shape, and particle size distribution of the resulting raw material magnetic powder. When the particle size of the prepared particles is measured with a wet laser diffraction particle size distribution analyzer, the size and distribution of the entire particles preferably substantially fall within the range of 0.05 to 20 μm, preferably 0.1 to 10 μm. Moreover, the average particle size of the precipitate is defined as the particle size corresponding to the 50th percentile of the cumulative undersize particle size distribution by volume, and is preferably within the range of 0.1 to 10 μm.

After separating the precipitate, it is preferable to subject the separated precipitate to desolvation in order to inhibit changes in particle size distribution, powder particle size, or other properties, as well as aggregation of the precipitate caused by evaporation of the solvent when the precipitate is re-dissolved in the remaining solvent during the heat treatment in the subsequent oxidation step. Specifically, when the solvent used is water, for example, the desolvation may be carried out by drying in an oven at 70 to 200° C. for 5 to 12 hours.

The precipitation step may be followed by separating and washing the precipitate. The washing step may be appropriately performed until the conductivity of the supernatant solution reaches 5 mS/m or less. The step of separating the precipitate may be carried out, for example, by mixing the precipitate with a solvent (preferably water) and subjecting the mixture to filtering, decantation, or other separation processes.

### Oxidation Step

The oxidation step includes firing the precipitate formed in the precipitation step to obtain an oxide containing Sm and Fe. For example, the precipitate may be converted into an oxide by heat treatment. The heat treatment of the precipitate needs to be performed in the presence of oxygen, for example in an air atmosphere. Moreover, since the presence of oxygen is necessary, the non-metal portion of the precipitate preferably contains an oxygen atom.

The heat treatment temperature during the oxidation step (hereinafter, oxidation temperature) is not limited, but it is preferably 700 to 1300° C., more preferably 900 to 1200° C. If the heat treatment temperature is lower than 700° C., oxidation tends to be insufficient. If the heat treatment temperature is higher than 1300° C., the resulting raw material magnetic powder tends not to have the desired shape, average particle size, or particle size distribution. The duration of heat treatment is not limited either, but it is preferably one to three hours.

The thus formed oxide is oxide particles in which Sm and Fe have been microscopically sufficiently mixed, and the shape, particle size distribution, and other properties of the precipitate have been reflected.

### Pretreatment Step

The pretreatment step includes heat-treating the oxide containing Sm and Fe in a reducing gas-containing atmosphere to obtain a partial oxide which is a partially reduced oxide.

Herein, the term “partial oxide” refers to a partially reduced oxide. The oxygen concentration of the oxide is not limited, but it is preferably not more than 10% by mass, more preferably not more than 8% by mass. If the concentration is more than 10% by mass, the heat generated by reduction with Ca as a reducing agent in the reduction step tends to increase, resulting in a higher firing temperature, which can lead to the formation of abnormally grown particles. Herein, the oxygen concentration of the partial oxide can be measured by non-dispersive infrared spectroscopy (ND-IR).

The reducing gas may be appropriately selected from hydrogen (H2), hydrocarbon gases such as carbon monoxide (CO) and methane (CH4), and other gases. In view of the cost, hydrogen gas is preferred. The flow rate of the gas may be appropriately adjusted within a range that does not cause scattering of the oxide. The heat treatment temperature during the pretreatment step (hereinafter, pretreatment temperature) may be in the range of at least 300° C. but not higher than 950° C., and is preferably at least 400° C., more preferably at least 750° C., but preferably lower than 900° C. When the pretreatment temperature is at least 300° C., the oxide containing Sm and Fe can be efficiently reduced. Moreover, when the pretreatment temperature is not higher than 950° C., growth and segregation of the oxide particles can be inhibited, thus allowing the desired particle size to be maintained.

### Reduction Step

The reduction step includes heat-treating the partial oxide in the presence of a reducing agent at a temperature of at least 920° C. but not higher than 1200° C. to obtain alloy particles. For example, reduction may be performed by bringing the partial oxide into contact with molten calcium or calcium vapor. In view of magnetic properties, the heat treatment temperature is preferably at least 950° C. but not higher than 1150° C., more preferably at least 980° C. but not higher than 1100° C. For a more uniform reduction reaction, the duration of heat treatment is preferably shorter than 120 minutes, more preferably shorter than 90 minutes. The lower limit of the duration of heat treatment is preferably at least 10 minutes, more preferably at least 30 minutes.

The metallic calcium as a reducing agent may be used in the form of granules or powder and preferably has a particle size of not more than 10 mm. This can more effectively inhibit aggregation during the reduction reaction. Moreover, the metallic calcium may be added in an amount that is 1.1 to 3.0 times, preferably 1.5 to 2.0 times the reaction equivalent (which is the stoichiometric amount needed to reduce the Sm oxide, but includes the amount needed to reduce Fe in the form of an oxide, if present).

In the reduction step, a disintegration accelerator may optionally be used together with the metallic calcium as a reducing agent. The disintegration accelerator may be appropriately used to facilitate the disintegration or granulation of the product in the water washing step described later. Examples of the disintegration accelerator include alkaline earth metal salts such as calcium chloride and alkaline earth oxides such as calcium oxide. The disintegration accelerator may be used in an amount of 1 to 30% by mass, preferably 5 to 28% by mass, relative to the amount of the Sm oxide used as the Sm source.

### Nitridation Step

The nitridation step includes nitriding the alloy particles obtained in the reduction step to obtain anisotropic magnetic particles. Since the alloy particles obtained in the reduction step are in porous bulk form due to the use of the particulate precipitate obtained in the precipitation step described above, they can be directly nitrided through heat treatment in a nitrogen atmosphere without the need for milling, thereby achieving uniform nitridation.

The heat treatment temperature during the nitridation of the alloy particles (hereinafter, nitridation temperature) is preferably 300 to 600° C., particularly preferably 400 to 550° C., and the heat treatment may be performed within the above temperature range in an atmosphere replaced with nitrogen. The duration of heat treatment may be selected such that the alloy particles can be sufficiently uniformly nitrided.

The product obtained after the nitridation step may contain, in addition to the magnetic particles, materials such as by-product CaO and unreacted metallic calcium, which may be combined into sintered bulk form. In this case, the product may be introduced into cooling water to separate CaO and metallic calcium as a suspension of calcium hydroxide (Ca(OH)2) from the magnetic particles. Further, the residual calcium hydroxide may be sufficiently removed by washing the magnetic particles with acetic acid or the like.

### Method of Producing Compound for Bonded Magnets

A method of producing a compound for bonded magnets according to the present embodiments preferably includes providing the phosphate-coated SmFeN-based anisotropic magnetic powder and kneading the magnetic powder with a resin. The bonded magnet obtained through this method has an high intrinsic coercive force. Moreover, the use of polypropylene as the resin improves hot water resistance. Here, the step of providing the phosphate-coated SmFeN-based anisotropic magnetic powder is preferably carried out by the above-described method.

### Kneading Step

In the step of kneading the phosphate-coated SmFeN-based anisotropic magnetic powder with a resin, a mixture of the phosphate-coated SmFeN-based anisotropic magnetic powder and a resin may be kneaded using a kneading machine such as a single screw kneader or a twin screw kneader at 180 to 300° C. For example, a pellet-shaped compound for bonded magnets may be obtained by mixing the magnetic powder with a resin powder in a mixer, followed by extruding a strand in a twin screw extruder, cooling the strand in the air, and then cutting the cooled strand into several millimeters using a pelletizer.

When the resin used is polypropylene, the weight average molecular weight of the polypropylene is preferably within the range of at least 20,000 but not more than 200,000. If the weight average molecular weight is less than 20,000, the molded bonded magnet tends to have lower mechanical strength. If the weight average molecular weight is more than 200,000, the compound for bonded magnets tends to have a higher viscosity. Moreover, to improve bonding to the magnetic powder having undergone coupling treatment, the polypropylene is preferably acid-modified. For example, polypropylene that is acid-modified by maleic anhydride may be suitably used. The degree of acid modification of the polypropylene is preferably at least 0.1% by mass but not higher than 10% by mass. If the degree is lower than 0.1% by mass, adhesion to the magnetic powder may be insufficient, so that the bonded magnet may have lower mechanical strength and water resistance. If the degree is higher than 10% by mass, the resin may have a higher water absorption rate, thus reducing the water resistance of the bonded magnet.

The amount of the phosphate-coated SmFeN-based anisotropic magnetic powder in the compound for bonded magnets is preferably at least 80% by mass but not more than 95% by mass. To obtain high magnetic properties, the amount is more preferably at least 90% by mass but not more than 95% by mass. Moreover, the amount of the resin in the compound for bonded magnets is preferably at least 3% by mass but not more than 20% by mass. To ensure fluidity, the amount is more preferably at least 5% by mass but not more than 15% by mass.

In addition to the phosphate-coated SmFeN-based anisotropic magnetic powder and the resin, a thermoplastic elastomer and/or an antioxidant such as a phosphorus antioxidant may be simultaneously kneaded. The mass ratio of the resin to the thermoplastic elastomer, if present, is preferably within the range of 90:10 to 50:50. In view of impact resistance, the mass ratio is more preferably within the range of 89:11 to 70:30. Moreover, the amount of the phosphorus antioxidant, if present, in the compound for bonded magnets is preferably at least 0.1% by mass but not more than 2% by mass.

Examples of resins usable in compounds for water-resistant bonded magnets include, in addition to the above-mentioned polypropylene (PP), polyphenylene sulfide (PPS), polyether ether ketone (PEEK), liquid crystal polymers (LCP), polyimide (PA), polyethylene (PE), and other crystalline resins having a low water absorption rate.

A mixture or polymer alloy of any of the above-mentioned crystalline resins and a non-crystalline resin having a glass transition temperature (Tg) of 100° C. or higher, such as modified polyphenylene ether (m-PPE), cyclic olefin polymer (COP), or cyclic olefin copolymer (COC) may be used to improve hot water resistance. For example, a polymer alloy of a modified polyphenylene ether (m-PPE) and polypropylene may be suitably used in the present disclosure.

### Compound for Bonded Magnets

A compound for bonded magnets according to the present embodiments contains the phosphate-coated SmFeN-based anisotropic magnetic powder according to the above-mentioned embodiments and a resin. The compound for bonded magnets containing the phosphate-coated SmFeN-based anisotropic magnetic powder according to the above-mentioned embodiments and a resin can be used to prepare a bonded magnet having an enhanced intrinsic coercive force. Here, the compound for bonded magnets can be produced by the above-described method.

### Method of Producing Bonded Magnet

A bonded magnet can be produced using the compound for bonded magnets and an appropriate molding machine. Specifically, for example, a bonded magnet may be produced by melting the compound for bonded magnets in the barrel of a molding machine and injection-molding the molten compound into a mold to which a magnetic field is applied to align the easy axes of magnetization (orientation step), followed by cooling for solidification and then magnetization with an air core coil or a magnetizing yoke (magnetization step).

The temperature of the barrel may be selected depending on the type of resin used and may be 160° C. to 320° C. Likewise, the temperature of the mold may be 30 to 150° C., for example. The orientation field in the orientation step may be generated using an electromagnet or a permanent magnet, and the magnitude of the magnetic field is preferably at least 4 kOe, more preferably at least 6 kOe. Moreover, the magnitude of the magnetizing field in the magnetization step is preferably at least 20 kOe, more preferably at least 30 kOe.

### Bonded Magnet

A bonded magnet according to the present embodiments contains the phosphate-coated SmFeN-based anisotropic magnetic powder according to the above-mentioned embodiments and a resin. The percentage of retention of the total flux of such a bonded magnet, after being maintained while immersed in hot water at 120° C. for 1000 hours, may be at least 95% of that before the test. When the total flux of the bonded magnet after the hot water resistance test where the bonded magnet is maintained while immersed in hot water at 120° C. for 1000 hours is at least 95%, preferably at least 96%, more preferably at least 97%, of the total flux before the test, it indicates that the bonded magnet has high resistance to hot water. Here, the total flux may be determined, for example, by measuring the change in magnetic flux in a search coil using a flux meter (Nihon Denji Sokki Co, Ltd., model: NFX-1000) when the molded bonded magnet placed within the search coil is pulled out of the search coil. Moreover, the bonded magnet can be produced by the above-described method.

The bonded magnet according to the present embodiments is resistant to hot water and is therefore suitable for use in the driving sources of fuel pumps for automobiles, motorcycles, or other vehicles or in water pumps, etc.

### EXAMPLES

### Example 1

An amount of 5.0 kg of FeSO4·7H2O was mixed and dissolved in 2.0 kg of pure water. To the mixture were further added 0.49 kg of Sm2O3 and 0.74 kg of 70% sulfuric acid, and they were well stirred and completely dissolved. Next, pure water was added to the resulting solution such that the final Fe and Sm concentrations were adjusted to 0.726 mol/L and 0.112 mol/L, respectively, to give a Sm—Fe sulfate solution.

### Precipitation Step

The entire amount of the prepared Sm—Fe sulfate solution was added dropwise with stirring to 20 kg of pure water kept at a temperature of 40° C. over 70 minutes from the start of the reaction, while simultaneously dropwise adding a 15% ammonia aqueous solution to adjust the pH to 7 to 8. Thus, a slurry containing a Sm—Fe hydroxide was obtained. The slurry was washed with pure water by decantation. Then, solid-liquid separation was performed to separate the hydroxide. The separated hydroxide was dried in an oven at 100° C. for 10 hours.

### Oxidation Step

The hydroxide obtained in the precipitation step was fired in the air at 1000° C. for one hour. After cooling, a red Sm—Fe oxide as a raw material powder was obtained.

### Pretreatment Step

An amount of 100 g of the Sm—Fe oxide was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by non-dispersive infrared spectroscopy (ND-IR) (EMGA-820, Horiba, Ltd.) and found to be 5% by mass. This shows that a black partial oxide was obtained in which the oxygen bonded to Sm remained unreduced while 95% of the oxygen bonded to Fe was reduced.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced into the furnace. The temperature inside the furnace was increased to 1045° C. and maintained for 45 minutes to obtain Fe-Sm alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours to obtain a magnetic particle-containing bulk product.

### Water Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice, followed by dehydration, drying, and then mechanical crushing to obtain a SmFeN-based anisotropic magnetic powder (average particle size 3 μm).

### Phosphate Treatment Step

A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO4 concentration to 2 and 20% by mass, respectively. An aluminum solution was also prepared by dissolving 4 g of aluminum chloride as an aluminum source in pure water. The process up to the water washing step was performed in multiple batches. Then, 1000 g of the resulting raw material SmFeN-based anisotropic magnetic powder was added to and stirred in dilute hydrochloric acid containing 70 g of hydrogen chloride for one minute to remove the oxidized surface film and contaminants, followed by repeating draining and filling of water until the supernatant had a conductivity of not higher than 100 μS/cm. Thus, a slurry containing 10% by mass of the raw material SmFeN-based anisotropic magnetic powder was obtained. While stirring the slurry, 100 g of the prepared phosphate treatment liquid and the aluminum solution containing 4 g of aluminum chloride dissolved therein were entirely introduced into the treatment tank. Specifically, the aluminum chloride was added in an amount of 0.4 parts by mass per 100 parts by mass of the raw material SmFeN-based anisotropic magnetic powder, i.e., the aluminum chloride was added in an amount of 0.003 mol, calculated as aluminum element, per 100 g of the raw material SmFeN-based anisotropic magnetic powder. In this way, the amounts of aluminum, calcium, manganese, and zinc added indicated in Table 1 are the amounts calculated as the respective metal elements per 100 g of the raw material SmFeN-based anisotropic magnetic powder. The pH of the phosphate treatment reaction slurry rose from 2.5 to 6 over 5 minutes. After stirring for 10 minutes, the reaction slurry was subjected to suction filtration, dehydration, and vacuum drying to obtain a phosphate-coated SmFeN-based anisotropic magnetic powder containing aluminum.

Oxidation Step after Phosphate Treatment

The temperature of the phosphate-coated SmFeN-based anisotropic magnetic powder obtained in the phosphate treatment step was gradually raised in an atmosphere of a gas mixture of nitrogen and air (oxygen concentration: 4%, 5 L/min) from room temperature to a maximum temperature of 170° C. At the maximum temperature, heat treatment was performed for 7 hours to obtain a slowly oxidized phosphate-coated SmFeN-based anisotropic magnetic powder.

### Example 2

A phosphate-coated SmFeN-based anisotropic magnetic powder was obtained as in Example 1, except that the amount of aluminum chloride was changed to 12 g. Then, slow oxidation was performed as in Example 1, whereby a slowly oxidized phosphate-coated SmFeN-based anisotropic magnetic powder was obtained.

### Example 3

A phosphate-coated SmFeN-based anisotropic magnetic powder was obtained as in Example 1, except that the amount of aluminum chloride was changed to 16 g. Then, slow oxidation was performed as in Example 1, whereby a slowly oxidized phosphate-coated SmFeN-based anisotropic magnetic powder was obtained.

### Example 4

A phosphate-coated SmFeN-based anisotropic magnetic powder was obtained as in Example 1, except that the amount of aluminum chloride was changed to 9 g, and 6 g of calcium chloride was further added. Then, slow oxidation was performed as in Example 1, whereby a slowly oxidized phosphate-coated SmFeN-based anisotropic magnetic powder was obtained.

### Comparative Example 1

A phosphate-coated SmFeN-based anisotropic magnetic powder was obtained as in Example 1, except that no aluminum chloride was added. Then, slow oxidation was performed as in Example 1, whereby a slowly oxidized phosphate-coated SmFeN-based anisotropic magnetic powder was obtained.

### Comparative Example 2

A phosphate-coated SmFeN-based anisotropic magnetic powder was obtained as in Example 1, except that 4 g of calcium chloride was added instead of the aluminum chloride. Then, slow oxidation was performed as in Example 1, whereby a slowly oxidized phosphate-coated SmFeN-based anisotropic magnetic powder was obtained.

### Comparative Example 3

A phosphate-coated SmFeN-based anisotropic magnetic powder was obtained as in Example 1, except that 8 g of manganese nitrate was added instead of the aluminum chloride. Then, slow oxidation was performed as in Example 1, whereby a slowly oxidized phosphate-coated SmFeN-based anisotropic magnetic powder was obtained.

### Comparative Example 4

A phosphate-coated SmFeN-based anisotropic magnetic powder was obtained as in Example 1, except that 4 g of zinc chloride was added instead of the aluminum chloride. Then, slow oxidation was performed as in Example 1, whereby a slowly oxidized phosphate-coated SmFeN-based anisotropic magnetic powder was obtained.

### Evaluation of Magnetic Powder

### Magnetic Properties

The phosphate-coated SmFeN-based anisotropic magnetic powders of Examples 1 to 4 and Comparative Examples 1 to 4 were measured for intrinsic coercive force (iHc) using a vibrating-sample magnetometer (VSM, Riken Denshi Co., Ltd., model: BHV-55). Table 1 shows the results.

### Oxidation Resistance Test

The phosphate-coated SmFeN-based anisotropic magnetic powders of Examples 1 to 4 and Comparative Examples 1 to 4 were subjected to an oxidation resistance test where the powders were kept at a temperature of 250° C. for 7 hours. Thereafter, the magnetic properties of the powders were measured. The rate of reduction in iHc was calculated from the iHc values before and after the oxidation resistance test. Table 1 shows the results.

### Water Resistance Test

The slowly oxidized phosphate-coated SmFeN-based anisotropic magnetic powders of Examples 1 to 4 and Comparative Examples 1 to 4 were subjected to a water resistance test where the powders were left in an environment of 85° C. and 85% humidity for 8 hours. Thereafter, the magnetic properties of the powders were measured. The rates of reduction in iHc of the slowly oxidized phosphate-coated SmFeN-based anisotropic magnetic powders were calculated from the iHc values before and after the water resistance test. Table 1 shows the results.

### Attached Amount of PO4 or Added Metal

The concentration of the added metal (aluminum, calcium, manganese, or zinc) in each of the phosphate-coated SmFeN-based anisotropic magnetic powders of Examples 1 to 4 and Comparative Examples 1 to 4 was measured by ICP atomic emission spectroscopy (ICP-AES). Moreover, the phosphorous concentration of each phosphate-coated SmFeN-based anisotropic magnetic powder was measured by ICP atomic emission spectroscopy (ICP-AES) and expressed as the concentration of phosphate ions (PO4). Table 1 shows the results.

TABLE 1

| | | | | | After oxidation | After water | | |
|---|---|---|---|---|---|---|---|---|
| | pH | Metal added during | | | resistance test | resistance test | | |
| | adjustment | phosphate treatment | | Before | Rate of | Rate of | ICP analysis | |
| | during | | Added | test | reduction | reduction | | Added |
| | phosphate | | amount | iHc | in iHc | in iHc | PO₄ | metal |
| | treatment | Type | [mol] | [kOe] | [%] | [%] | [wt %] | [wt %] |
| Comparative | Without pH | — | 0 | 15.2 | 39.6 | 11.5 | 0.47 | — |
| Example 1 | adjustment | | | | | | | |
| | (2.5→6) | | | | | | | |
| Comparative | Without pH | Ca | 0.0038 | 15.2 | 29.6 | 8.8 | 0.49 | 0.04 |
| Example 2 | adjustment | | | | | | | |
| | (2.5→6) | | | | | | | |
| Comparative | Without pH | Mn | 0.0027 | 15.1 | 41.1 | 4.9 | 0.56 | 0.18 |
| Example 3 | adjustment | | | | | | | |
| | (2.5→6) | | | | | | | |
| Comparative | Without pH | Zn | 0.0032 | 15.5 | 39.4 | 4.0 | 0.50 | 0.14 |
| Example 4 | adjustment | | | | | | | |
| | (2.5→6) | | | | | | | |
| Example 1 | Without pH | Al | 0.0030 | 16.1 | 33.0 | 5.1 | 0.60 | 0.06 |
| | adjustment | | | | | | | |
| | (2.5→6) | | | | | | | |
| Example 2 | Without pH | Al | 0.0091 | 16.6 | 27.5 | 3.4 | 0.83 | 0.13 |
| | adjustment | | | | | | | |
| | (2.5→6) | | | | | | | |
| Example 3 | Without pH | Al | 0.012 | 17.2 | 29.7 | 4.2 | 0.98 | 0.17 |
| | adjustment | | | | | | | |
| | (2.5→6) | | | | | | | |
| Example 4 | Without pH | Al/Ca | 0.0066/0.0050 | 16.1 | 11.3 | 0.2 | 0.68 | 0.087/0.028 |
| | adjustment | | | | | | | |
| | (2.5→6) | | | | | | | |

The results in Table 1 demonstrate that the phosphate-coated SmFeN-based anisotropic magnetic powders of Examples 1 to 4, where an aluminum source was added to the slurry during the phosphate treatment step, exhibited an enhanced intrinsic coercive force (iHc) and an increased amount of phosphate attached to the magnetic powder compared to the phosphate-coated SmFeN-based anisotropic magnetic powders of Comparative Examples 1 to 4, where no aluminum was added. Also, in Example 4, where an aluminum source and a calcium source were added to the slurry during the phosphate treatment step, the oxidation resistance and water resistance were further enhanced.

### Example 5

The process up to the water washing step was performed as in Example 1 to obtain a raw material SmFeN-based anisotropic magnetic powder. A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO4 concentration to 2.5 and 20% by mass, respectively. An aluminum solution was also prepared by dissolving 12 g of aluminum chloride as an aluminum source in pure water. Then, 1000 g of the raw material SmFeN-based anisotropic magnetic powder obtained in the water washing step was added to and stirred in dilute hydrochloric acid containing 70 g of hydrogen chloride for one minute to remove the oxidized surface film and contaminants, followed by repeating draining and filling of water until the supernatant had a conductivity of not higher than 100 μS/cm. Thus, a slurry containing 10% by mass of the raw material SmFeN-based anisotropic magnetic powder was obtained. While stirring the slurry, 100 g of the prepared phosphate treatment liquid and the aluminum solution were entirely introduced into the treatment tank, and then the phosphate treatment reaction slurry was maintained for 30 minutes while introducing 6% by mass hydrochloric acid as needed to control the pH of the reaction slurry within the range of 2.5±0.1. Subsequently, the reaction slurry was subjected to suction filtration, dehydration, and vacuum drying to obtain a phosphate-coated SmFeN-based anisotropic magnetic powder containing aluminum. Then, the temperature of 1000 g of the phosphate-coated SmFeN-based anisotropic magnetic powder was gradually raised in an atmosphere of a gas mixture of nitrogen and air (oxygen concentration: 4%, 5 L/min) from room temperature to a maximum temperature of 230° C. At the maximum temperature, heat treatment was performed for 4 hours to obtain a slowly oxidized phosphate-coated SmFeN-based anisotropic magnetic powder.

### Comparative Example 5

A phosphate-coated SmFeN-based anisotropic magnetic powder was obtained as in Example 5, except that no aluminum source was added. Then, slow oxidation was performed as in Example 5, whereby a slowly oxidized phosphate-coated SmFeN-based anisotropic magnetic powder was obtained.

### Evaluation of Magnetic Powder

### Magnetic Properties

The phosphate-coated SmFeN-based anisotropic magnetic powders of Example 5 and Comparative Example 5 were measured for intrinsic coercive force (iHc) using a vibrating-sample magnetometer (VSM, Riken Denshi Co., Ltd., model: BHV-55). Table 2 shows the results.

### Oxidation Resistance Test

The phosphate-coated SmFeN-based anisotropic magnetic powders of Example 5 and Comparative Example 5 were subjected to an oxidation resistance test where the powders were kept at a temperature of 230° C. for 4 hours. Thereafter, the magnetic properties of the powders were measured. The rate of reduction in iHc was calculated from the iHc values before and after the oxidation resistance test. Table 2 shows the results.

### Water Resistance Test

The slowly oxidized phosphate-coated SmFeN-based anisotropic magnetic powders obtained in Example 5 and Comparative Example 5 were subjected to a water resistance test where 1 g of each powder was immersed in water at 95° C. for 8 hours. Thereafter, the magnetic properties of the powders were measured. The rates of reduction in iHc of the slowly oxidized phosphate-coated SmFeN-based anisotropic magnetic powders were calculated from the iHc values before and after the water resistance test. Table 2 shows the results.

### Attached Amount of PO4 or Added Metal

The concentration of the added metal (aluminum) in each of the phosphate-coated SmFeN-based anisotropic magnetic powders of Example 5 and Comparative Example 5 was measured by ICP atomic emission spectroscopy (ICP-AES). Moreover, the phosphorous concentration of each phosphate-coated SmFeN-based anisotropic magnetic powder was measured by ICP atomic emission spectroscopy (ICP-AES) and expressed as the concentration of phosphate ions (PO4). Table 2 shows the results.

TABLE 2

| | | | | | After oxidation | After water | | |
|---|---|---|---|---|---|---|---|---|
| | pH | Metal added during | | | resistance test | resistance test | | |
| | controlled | phosphate treatment | | Before | Rate of | Rate of | | |
| | during | | Added | test | reduction | reduction | ICP analysis | |
| | phosphate | | amount | iHc | in iHc | in iHc | PO₄ | Al |
| | treatment | Type | [mol] | [kOe] | [%] | [%] | [wt %] | [wt %] |
| Comparative | 2.5 | — | 0 | 19.8 | 8.9 | 41.1 | 1.00 | — |
| Example 5 | | | | | | | | |
| Example 5 | 2.5 | Al | 0.0091 | 18.0 | 1.7 | 5.3 | 1.40 | 0.10 |

The results in Table 2 demonstrate that the phosphate-coated SmFeN-based anisotropic magnetic powder of Example 5, where an aluminum source was added to the slurry during the phosphate treatment step, exhibited greatly enhanced oxidation resistance and an increased amount of phosphate attached to the magnetic powder compared to the phosphate-coated SmFeN-based anisotropic magnetic powder of Comparative Example 5.

What is claimed is:

1. A method of producing a phosphate-coated SmFeN-based anisotropic magnetic powder, the method comprising
a phosphate treatment comprising stirring a slurry containing a raw material SmFeN-based anisotropic magnetic powder, water, a phosphate source, and an aluminum source to obtain a SmFeN-based anisotropic magnetic powder having a surface coated with a phosphate.

2. The method of producing a phosphate-coated SmFeN-based anisotropic magnetic powder according to claim 1,
further comprising in the phosphate treatment adding an inorganic acid to the slurry to adjust a pH of the slurry to at least 1 but not higher than 4.5.

3. The method of producing a phosphate-coated SmFeN-based anisotropic magnetic powder according to claim 2,
wherein the inorganic acid is added to adjust the pH of the slurry for at least 10 minutes.

4. The method of producing a phosphate-coated SmFeN-based anisotropic magnetic powder according to claim 2,
wherein the pH of the slurry is adjusted to at least 1.6 but not higher than 3.9.

5. The method of producing a phosphate-coated SmFeN-based anisotropic magnetic powder according to claim 1,
further comprising heat-treating the SmFeN-based anisotropic magnetic powder having the surface coated with the phosphate at a temperature of at least 150° C. but not higher than 330° C. in an oxygen-containing atmosphere.

6. The method of producing a phosphate-coated SmFeN-based anisotropic magnetic powder according to claim 1,
wherein an amount of an aluminum element in the aluminum source is not higher than 0.02 mol per 100 g of the raw material SmFeN-based anisotropic magnetic powder.

7. The method of producing a phosphate-coated SmFeN-based anisotropic magnetic powder according to claim 1,
wherein the aluminum source is at least one selected from the group consisting of aluminum chloride and aluminum sulfate.

8. The method of producing a phosphate-coated SmFeN-based anisotropic magnetic powder according to claim 1,
wherein the slurry further contains a calcium source.

9. The method of producing a phosphate-coated SmFeN-based anisotropic magnetic powder according to claim 1,
wherein the phosphate-coated SmFeN-based anisotropic magnetic powder has a phosphate content of higher than 0.5% by mass.
